(19) United States
(12) Patent Application Publication
(10) Pub. No.: US 2006/0074166 A1
(43) Pub. Date: Apr. 6, 2006

(54) Moldable high dielectric constant nano-composites

(75) Inventors: Kirk M. Slenes, Albuquerque, NM (US); Christopher Labanowski, Albuquerque, NM (US)

Correspondence Address: PEACOCK MYERS, P.C., 201 THIRD STREET, N.W., SUITE 1340, ALBUQUERQUE, NM, 87102, US

(73) Assignee: TPL, Inc. title and interest in an application, Albuquerque, NM (US)

(21) Appl. No.: 11/019,810

(22) Filed: Dec. 20, 2004

Related U.S. Application Data
(60) Provisional application No. 60/531,432, filed on Dec. 19, 2003.
(60) Provisional application No. 60/576,383, filed on Jun. 1, 2004.

(51) Int. Cl. C08K 3/22

(52) U.S. Cl. 524/436

(57) ABSTRACT

The present invention comprises the use of high dielectric constant composite materials comprising a high particle loading to form molded structures comprising three dimensional shapes. The composite material comprises ceramic dielectric particles, preferably nano-sized particles, and a thermoset polymer system. The composite material exhibits a high energy density.

### CROSS-REFERENCE TO RELATED APPLICATIONS

This application claims the benefit of the filing of U.S. Provisional Patent Application Ser. No. 60/531,432, entitled “Moldable High Dielectric Constant Nano-Composites”, filed Dec. 19, 2003, and the specification thereof is incorporated herein by reference. This application also is related to U.S. Provisional Patent Application Ser. No. 60/576,383, entitled “Structured Composite Dielectrics”, filed Jun. 1, 2004, and the specification thereof is incorporated herein by reference. This application also is related to U.S. Pat. No. 6,608,760, entitled “Dielectric Material Including Particulate Filler” and U.S. Pat. No. 6,616,794, entitled “Integral Capacitance for Printed Circuit Board Using Dielectric Nanopowders”, and the specifications and claims thereof are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. N00178-04-C01013 awarded by the U.S. Navy.

### BACKGROUND OF THE INVENTION

### Field of the Invention (Technical Field)

The present invention relates to moldable dielectric nano-composite materials.

### BRIEF SUMMARY OF THE INVENTION

The present invention comprises a moldable composite comprising at least one thermoset polymer system and at least one particle filler comprising ceramic particles. The composite preferably comprises a concentration of the particles of from between approximately 35 percent by volume and 70 percent by volume, more preferably of from between approximately 40 percent by volume and 65 percent by volume, and most preferably of from between approximately 50 percent by volume and 60 percent by volume.

The composite of preferably comprises an energy density of greater than approximately 6 joules/cc, and more preferably of greater than approximately 12 joules/cc.

The composite of the present invention preferably comprises ceramic particles which preferably comprise barium titanate, and more preferably barium strontium titanate. The thermoset polymer system preferably comprises a liquid epoxy polymer. The ceramic particles preferably comprise nano-size particles, more preferably a size of between approximately 10 nm and 1 μm, more preferably still of between approximately 50 nm and 500 nm, and most preferably of between approximately 100 nm and 300 nm. The composite of the present invention is solvent-free.

The invention also comprises a molded/moldable structure comprising the composite of the present invention. The composite of the moldable structure are preferably aligned, and preferably in an arrangement consistent with the application of an alternating high voltage current to said composite.

The invention also comprises a method for fabricating a molded structure comprising a high dielectric constant composite, the method comprising combining at least one thermoset polymer system and at least one particle filler comprising ceramic particles, the composite comprising a concentration of said particles of from between approximately 35 percent by volume and 70 percent by volume, more preferably of from between approximately 40 percent by volume and 65 percent by volume, and most preferably of from between approximately 50 percent by volume and 60 percent by volume. In the method, the composite comprises an energy density of greater than approximately 6 joules/cc, and more preferably of greater than approximately 12 joules/cc.

In the method, the ceramic particles preferably comprise barium titanate, and more preferably barium strontium titanate. The thermoset polymer system of the method preferably comprises a liquid epoxy polymer. The ceramic particles of the method preferably comprise nano-size particles. The method preferably comprises applying an alternating high voltage current to the composite to align the ceramic particles in the composite.

The method preferably comprises ball milling the ceramic particles prior to mixing. The method preferably also comprises dispersing the ceramic particles in a solvent prior to mixing the ceramic particles with the thermoset polymer system and removing the solvent after addition of the thermoset polymer system. The method comprises a mold.

The method preferably comprises applying a heat of a moderate temperature to the composite to control the flow of the composite and disposing the composite into the mold. The temperature is below the activation temperature for curing of the composite and preferably between approximately 30° C. and 80° C.

In the method, the mold may comprise a thin cross-section which is preferably oriented so that the axis of the thin cross-section is vertical. The composite is preferably pumped into the mold. Preferably, the composite and the mold are placed under a vacuum of less than atmospheric pressure, more preferably under a vacuum of from between approximately 50 mtorr and 250 mtorr, and most preferably under a vacuum of from between approximately 60 mtorr and 200 mtorr.

The method comprises allowing the composite to cure and preferably comprises applying a pressure to the composite during curing so that bubbles can compress. The pressure is preferably between approximately 50 psi and 150 psi and more preferably between approximately 90 psi and 110 psi.

A primary object of the present invention is to provide for moldable composite dielectric materials that exhibit a combination of a high dielectric constant and high dielectric strength to achieve high energy density capabilities.

A primary advantage of the present invention is that it provides for higher energy storage capability.

Other objects, advantages and novel features, and further scope of applicability of the present invention are set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into, and form a part of, the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is an electrode configuration for producing particle alignment;

FIG. 2 is a graph showing the influence of nano-particle filler concentration and alignment on dielectric constant;

FIG. 3 is a graph showing the influence of nano-particle filler on composite dielectric strength;

FIG. 4 is a graph showing the influence of nano-particle concentration and alignment on composite energy density;

FIG. 5 is a graph showing the effect of temperature on the capacitance for a barium titanate and a barium strontium titanate composite;

FIG. 6 is a graph showing the dielectric strength of a barium strontium titanate composite;

FIG. 7 is a graph showing the dielectric properties versus frequency for a barium strontium titanate composite; and

FIG. 8 is a graph showing dielectric constant versus frequency for a barium strontium titanate composite and a barium titanate composite.

### DETAILED DESCRIPTION OF THE INVENTION

The present invention comprises the use of high dielectric constant composite materials with high particle loading to form molded structures comprising three dimensional shapes. The dielectric materials encompassed in the present invention comprise a unique set of processing and dielectric performance characteristics and exhibit high voltage infiltration and encapsulation. The materials are based on a combination of inorganic powders, dispersants, polymers and cure agents to form a composite material.

The composite materials are refined to provide for fabrication of a void-free/defect-free dielectric encapsulation. The structured composite materials of the present invention can be produced in a three-dimensional structure or film. As used herein “molded” or “moldable” material is defined as a slurry, a fluid, or other like material, with high particle loading that can be cast into a mold or similar structure to produce a three-dimensional structure.

The composite materials comprise a combination of high dielectric constant and high dielectric strength to achieve materials with high energy storage density capabilities to make power applications more efficient. The energy density of the materials of the present invention are preferably greater than approximately 6 Joules/cc, more preferably greater than approx. 9 Joules/cc, and most preferably greater than approximately 12 Joules/cc. Thus, the invention provides for the production of structured composite materials which improve capacitor development and which exhibit higher energy storage capabilities.

Non-refractory ferroelectric particles are preferably utilized in the present invention. In the preferred embodiment, ceramic dielectric particles, preferably nano-size dielectric particles, are dispersed in a polymer matrix. These ceramic particles typically comprise non-refractory ferroelectric particles. The methods of the present invention providing for a higher loading of the particles in the polymer matrix and the use of nano-sized dielectric particles results in the increased performance of the composite material of the present invention.

Preferably, the ceramic powders utilized comprise barium titanate and more preferably barium strontium titanate. Examples of such powders are those synthesized using a proprietary (TPL, Inc.) low temperature hydrothermal process. Nano-size particles are preferred as they exhibit better voltage performance characteristics. These nano-size particles are uniform and produce less of an electrical disruption or reduced flaw size within the composite and demonstrate greater retention of the polymer's intrinsic dielectric strength. The preferred sizes include, but are not limited to, those between approximately 10 nm and 1 μm, more preferably between approximately 50 nm and 500 nm, and more preferably still between approximately 100 nm and 300 nm. The preferred concentrations for the powders is from between approximately 35 vol. % and 70 vol. %, more preferably from between approximately 40 vol. % and 65 vol. %, and most preferably from between approximately 50 vol. % and 60 vol. %. The composite and method of the present invention wherein high particle loading is performed achieves such loading without negatively affecting the moldable characteristic of the composite of the present invention.

In the preferred embodiment, the polymer comprises a thermosetting (thermoset) polymer system including, but not limited to, urethane, silicone, acrylic, and epoxy. More preferable for the purpose of the present invention is the use of a liquid epoxy polymer that can be filled into mold structures. Similar materials may be utilized. As the preferred polymer comprises a thermoset polymer, the composite material preferably also comprises a catalyst or cure agent. The final composite material preferably comprises no solvent, although a solvent is utilized in the preparation of the slurry. The preferable polymer and catalyst ratio is one that provides for a reasonable combination of working time (for example, >1.0 hr. at room temperature) and cure conditions (for example, <24 hrs. at, for example, 100° C.).

In the preferred method of the present invention, the barium titanate (or similar material) slurries are preferably prepared by ball milling. Powder dispersions are preferably made first in a solvent (e.g., acetone) using a standard milling process. The solvent provides for better dispersion and higher loading of the particles. Preferably, a first portion of the polymer is added to the dispersion toward the end of the milling process. Following milling, the second portion of the polymer (i.e., the cure agent) is added.

The solvent is then preferably removed from the slurry so that the final composite is solvent-free. Removal of the solvent is preferred because its presence in the final material impedes the properties sought for, and the structure of, the final structured composite. Removal is preferably done by rotary evaporation, and preferably under the application of vacuum and heat. The preferred heat utilized is based on the boiling point of the solvent utilized and removal continues until the solvent is removed (e.g., when it is observed that boiling has stopped). Other methods or steps for slurry preparation known in the art may be utilized. Other nano-size particles of different compositions and made by different processes may also be used in the invention.

Following removal of the solvent, the slurry is disposed in a mold. Preferably, the slurry and the mold are heated to a preferably moderate temperature to ensure for a good material flow. The temperature is preferably above ambient temperature and less than the activation temperature for curing. In the case of the liquid epoxy composite system, the preferred temperature range is from between approximately 30° C. and 80° C.

The filled mold is then preferably placed under a moderate vacuum of preferably less than atmospheric pressure, more preferably from between approximately 50 mtorr and 250 mtorr, and more preferably still from between approximately 60 mtorr and 200 mtorr. The vacuum helps to expand and elevate any gas to the slurry surface effectively eliminating voids from the material.

Following the application of the vacuum, the filled mold is allowed to cure. During the curing process, the material is preferably subjected to heat and pressure. Applying pressure causes any bubbles to compress, and the preferred pressure is that which causes the bubbles to compress. The preferred pressure comprises a nitrogen or other inert gas pressure with a preferred range from between approximately 50 psi and 150 psi, and more preferably from between approximately 90 psi and 110 psi. The preferred temperature is that which provides for an acceptable or desired cure time which is dependent on the material components utilized.

The combination of the composite material's forming properties and electric properties are particularly useful. The composite material possesses the forming characteristics of a polymer with a dielectric constant that can be increased to an order of a magnitude over conventional polymers (e.g., >30 versus 3) (dielectric constant of >30 is possible in ceramics materials typical in the art but the application of those materials is limited to the process ability of the ceramics).

Thus, the present invention provides for the production of structured composite dielectric moldable structures and films. For example, molded sheet structures (i.e., structures with a relatively thin profile in relation to their length and width) may be formed with capacitor function to be sandwiched between electrodes. Other filled polymer systems typically exhibit dielectric constants of less than 10. The present invention provides for dielectric constants of greater than 60. When fabricating such sheet molded structures, a vertical mold, preferably a metal mold, and more preferably a Teflon® coated aluminum mold, is utilized. Preferably, the slurry is pumped into the mold as pouring into a relatively thin mold is difficult. The vertical orientation of the mold for sheet formation is preferred because it eliminates variations in the thickness of the sheet and any bubbles that form during the filling process can rise to the top and out the opening of the mold into the atmosphere.

Because the composite material of the present invention comprises a combination of high dielectric constant and high dielectric strength, it offers superior energy density capabilities for the fabrication of compact power sources.

Preferably, following infiltration, the polymer may be cured to form a final capacitor structure. Variations in the preparation of the composite material include, but are not limited to, concentration of material constituents to control properties and structuring of the inorganic particle phase.

A trade-off between the dielectric constant and dielectric strength is associated with the relative volume fraction of the ceramic and the polymer utilized. An increase in the ceramic filler leads to an increase in dielectric constant and a decrease in dielectric strength. In another embodiment, the ceramic filler can be replaced with a metal filler to induce a wider range of electrical properties. However, this can result in an increase in dielectric constant, a reduction in insulation resistance, and an increase in dielectric loss.

In the preferred embodiment, particles are aligned in the composite to enhance dielectric properties. Preferably, alternating high voltage current can be applied to the composite resin prior to polymer cure to induce particle movement into desired structures. An example includes applying approximately 1.0 kHz to a 50 percent by weight barium titanate/epoxy composite during the cure process to induce chaining of the particles in the polymer matrix. The particles orient in the polymer to form a 1-3 composite structure (particle chaining parallel to the electric field). This results in a significant increase in dielectric constant. Oriented composites prepared in accordance with the present invention have shown a dielectric constant of, for example, 12.8 versus 6.8 for the non-oriented composites. There is no observed loss in dielectric strength of the composite associated with the particle structuring.

Alignment of the particles in the composite material is preferably performed using a power source with high voltage and high frequency such as, for example, a high voltage alternating current power amplifier. The available frequency control allows for use of a signal specific to the material under evaluation. Several polymers demonstrate poor alignment due to high dielectric loss, primarily low frequencies for the epoxies. There is an apparent correlation between loss measurements performed using a LCR meter and good particle alignment. Also, higher voltage allows for the generation of higher electric fields which increases the rate of fibril formation. Effective particle alignment has been demonstrated over a range of applied electric fields. While rate of alignment is dependent on the magnitude of the applied electric field, particle alignment in less than a few seconds is preferred with an applied electric field between 0.1 V/μm and 10 V/μm. Finally, the higher electric fields increase fibril length with particle continuity forming between electrodes, as opposed to partial fiber formation propagating from the electrodes.

Higher titanate concentrations provide for a significant increase in dielectric constant without significantly impacting the voltage performance. For example, an 80 percent by weight composite (0-3 structure) allows for a dielectric constant of 30 which is an order of magnitude increase in dielectric constant over the base polymer. If the relative improvement in dielectric constant in the 1-3 composite created as a result of particle alignment is possible in the 80 wt % composite with a minor loss in dielectric strength, an energy density of over 10 Joules/cc is possible.

### EXAMPLE

1. Summary

A composite dielectric material was fabricated utilizing the methods of the present invention. The composite material comprised a high dielectric constant (ε>50) and a high dielectric strength (V/t=2.4 MV/cm).

Several material preparation and processing parameters were established in the preparation of the composite material including composite material preparation, methods for molding the composite, processes for ensuring a void-free dielectric (e.g., vacuum and pressure), polymer cure conditions, and metal deposition processes for the final capacitor test part.

Test parts that were molded and cured using 87% by weight of 200 nm barium titanate powder and liquid epoxy exhibited the following properties:

Part diameter=4″

Dielectric thickness=60 mils

Capacitance=3.0 nF; Dielectric constant=50−60 (frequency dependent)

Dissipation factor=1.6%

Voltage capability>80 kV; >1.33 MV/cm (limited to 50% to 60% of material capability because of electrical field enhancement, i.e., 2×, at electrode edges) (1.0 DC hold)

2. Baseline Material System

The composite material selected for development and characterization was a solvent-less composition that included a nano-size barium titanate powder, a liquid epoxy, and a catalyst or cure agent. A solvent was used as a dispersant during slurry formation. The high dielectric constant barium titanate was fixed at a weight fraction to provide a final dielectric constant of between approximately 50 and 50, frequency dependent. The polymer and catalyst ratio was investigated to establish a reasonable combination of working time (>1.0 hr. at room temperature) and cure conditions (<24 hrs. at 100° C).

In support of refining the baseline material system, a test fixture was fabricated to allow electrical evaluation during the polymer cure. An LCR meter was used with the test fixture to monitor capacitance and dissipation factor of the dielectric in an environmental chamber. Data acquired as a function of time was used to monitor polymer cure and establish the relationship between cure conditions and catalyst concentration. (Capacitance and dissipation of the composite is significantly dependent on polymer cure.)

Forming composite test parts was performed by casting in a Teflon® mold. The composite slurry was poured and cured in an image of the final part. Filling of the mold was controlled by the depth of the image formed in the Teflon® and the slurry weight.

The Teflon® mold was machined out of a 6 inch by 6 inch by 0.5 inch plate. On its top surface, the plate comprised a circular groove. The outer circumference of the groove was 0.5 inch from each edge of the plate. The groove comprised two 45 degree beveled sides with a 0.5 inch wide bottom surface. The curve radius of the groove's sides was 0.25 inch.

Pressure and temperature were used to aid in the removal of trapped gas or voids. The slurry and the mold were heated to a moderate temperature of approximately 60° C. to ensure for proper material flow. The filled mold was then placed under a moderate vacuum (approximately 200 mtorr) to expand and elevate any gas to the slurry surface. Following vacuum, the mold was placed into a heated pressure vessel and allowed to cure for approximately 18 hours. Temperature was maintained at approximately 100° C. with a nitrogen pressure set at 100 psi. Following cure, the final part was released from the mold.

3. Particle Alignment

A Trek power amplifier (Model #623B) was used in combination with a Stanford Research AC signal generator (Model #DS345 ). A sinusoidal, low voltage signal from the generator could be amplified at frequencies up to 40 kHz and at a voltage of 2.0 kV rms.

Microscope evaluations of the fibril formation at 500× were used to refine the alignment conditions for the composite. Continuity of fiber formation and rate of fiber formation were evaluated throughout the available frequency range and applied field stress. Results from the microscope evaluations are shown in Table 1.

TABLE 1
Alignment Behavior/Fibril Formation as a
Function of Frequency and Voltage Stress

| | Applied Field Stress on Composite | | |
|---|---|---|---|
| Frequency | <1.0 V/μm | 1.0-3.0 V/μm | 3.0-8.0 V/μm |
| <100 Hz | very slow | swirling movement | edge fibers/ |
| | movement | | swirling |
| 100-600 Hz | no movement | edge fibers/ | edge fibers/ |
| | | movement | swirling |
| 600 Hz-1.0 kHz | edge fibers | long edge fibers | continuous |
| | | | fibers |
| 1.0-10 kHz | no movement | no movement | no movement |

Results from the microscope evaluations show that the composite alignment conditions depend significantly on frequency and field stress. An optimum frequency of 700 Hz was defined for the composite system. Fiber formation was rapid (<5 seconds) with continuous fibers forming between electrodes at high stress, 3.0 to 8.0 V/μm.

Barium titanate particles that were aligned in a liquid epoxy using 700 Hz and a field stress of approximately 8.0 V/μm in less than one second showed clear formation of fibers under stress.

4. Sheet Manufacturing

Uniformly thick and defect-free sheets of the nano-composite dielectric material were manufactured in accordance with the present invention using a Teflon®-coated, aluminum mold. The structure had approximate dimensions of 42″×4″×0.10″. A beveled edge of 0.020″ was included along the active length at 3″ on top and 3.5″ on the bottom. The mold was oriented vertically, and the slurry was pumped into the mold using a peristaltic pump. Prior to filling, the mold and the slurry were pre-heated. The filled mold was then placed in a tube-shaped oven and allowed to cure overnight under temperature and pressure. The material was removed from the mold and allowed to cure for an additional day under temperature.

5. Film Manufacturing

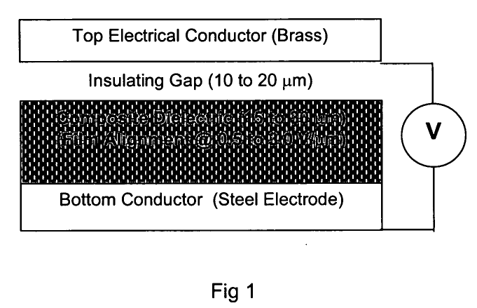

Structured composite films in accordance with the present invention were fabricated. Films of the liquid composite slurry were initially coated onto a conductive metal or polymer substrate. Samples were then placed on a heated substrate with an offset electrode to apply an electric field. The first electrical contact was located on the base while the top electrode was offset from the surface of the coating (See FIG. 1). Consideration for the added series dielectric associated with the releasable substrate was required for continuous film production. Higher AC voltage was required to achieve the same electric field across the composite.

6. Dielectric Properties

A significant increase in energy storage capability was demonstrated with the addition and alignment of the nano-size titanate powders. Composite films were prepared, alignment was introduced, polymer was cured and dielectric constant was measured. The results demonstrate a significant performance enhancement in the 50 percent by weight composite.

A 110 percent improvement in dielectric constant (3.0 to 6.4) was observed with the titanate addition in a 0-3 composite structure. This improvement was further enhanced through structuring of the composite. The 1-3 composite film that was prepared using 700 Hz and a field stress of 4.3 V/μm demonstrated a 425% increase in dielectric constant (3.0 to 12.8). Structuring of the particles increased the benefit of the titanate addition by a factor of three.

Dielectric strength of the composite material was shown to be independent of particle structuring. Voltage stress data on aligned and unaligned composites was collected on 50 percent by weight nano-composites. Test data collected on the 14 μm films demonstrated a voltage capability of 3.5 kV and a voltage stress of 250 V/μm.

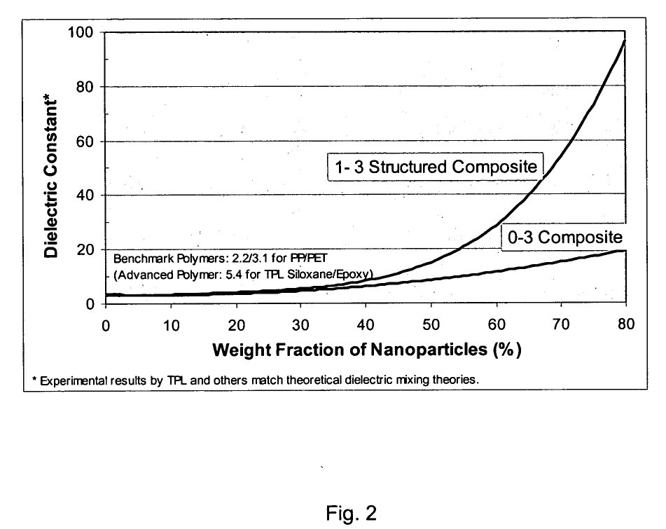

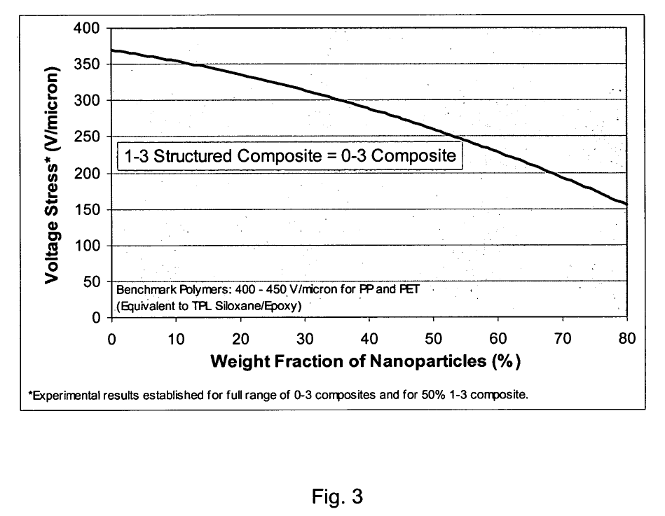

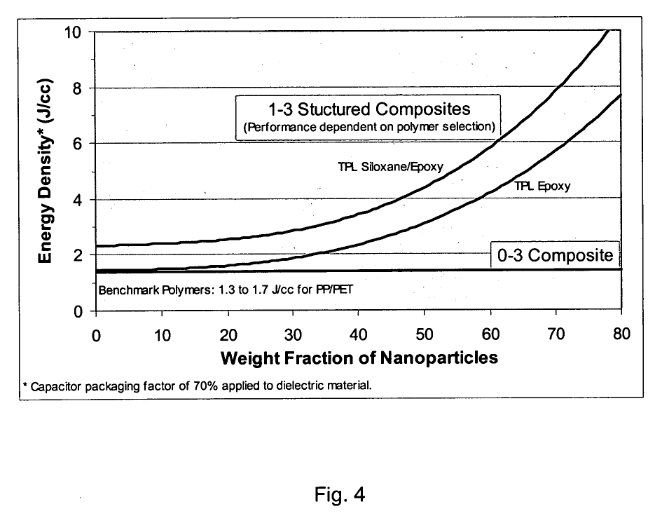

The benefits of the structured composite for high energy density applications are represented in FIGS. 2, 3 and 4. The observed benefits of particle alignment were applied to higher volume fractions of the nano-particle filler (FIGS. 2 and 3). Dielectric strength data of the 0-3 nano-composite was applied in order to estimate the energy density potential for the aligned composite dielectric (FIGS. 3 and 4).

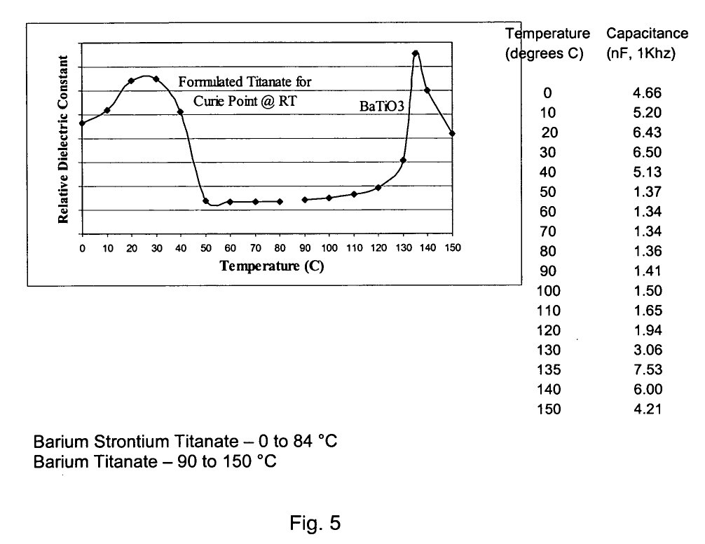

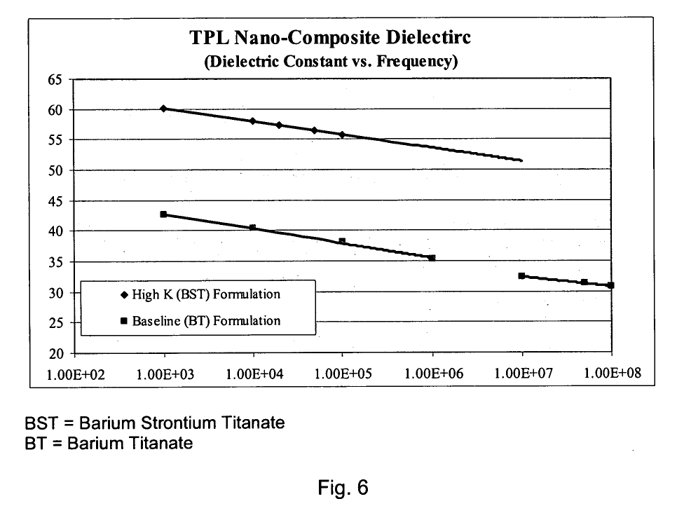

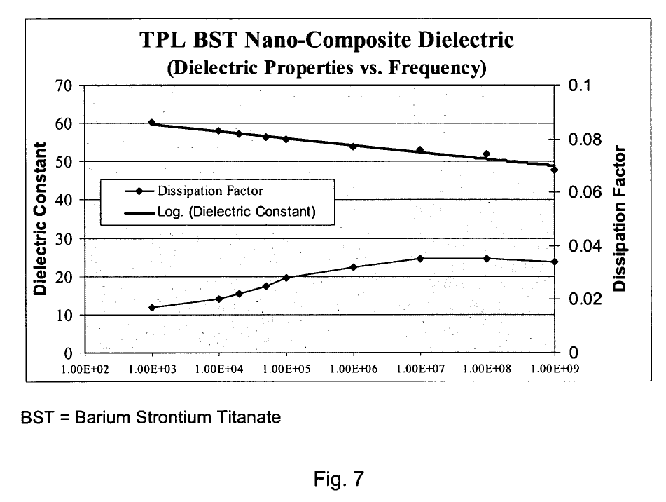

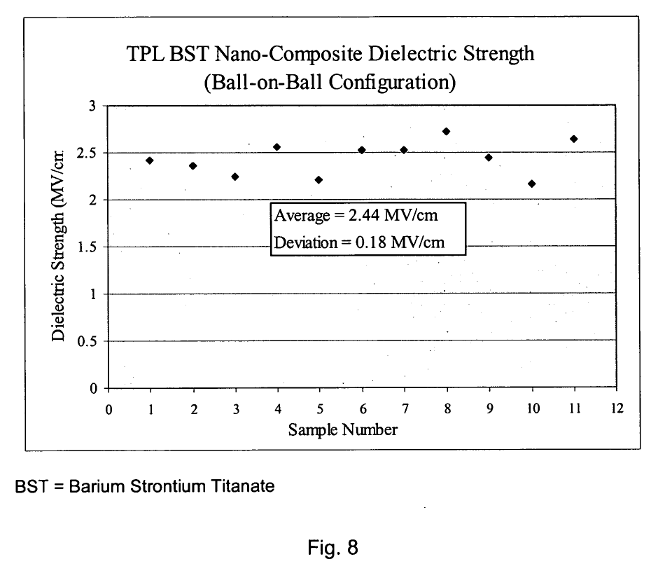

FIGS. 5-8 show the enhanced properties for materials utilizing barium titanate and barium strontium titanate. The dielectric constant maximum was shifted to room temperature in the barium strontium titanate.

The preceding examples can be repeated with similar success by substituting the generically or specifically described reactants and/or operating conditions of this invention for those used in the preceding examples.

Although the invention has been described in detail with particular reference to the preferred embodiments in the attachment, other embodiments can achieve the same results. Variations and modifications of the present invention will be obvious to those skilled in the art and it is intended to cover all such modifications and equivalents. The entire disclosures of all references, applications, patents, and publications cited above, and of the corresponding application(s), are hereby incorporated by reference.

What is claimed is:

1. A moldable composite comprising at least one thermoset polymer system and at least one particle filler comprising ceramic particles, wherein said composite comprises a concentration of said particles of from between approximately 35 percent by volume and 70 percent by volume.

2. The composite of claim 1 comprising a concentration of said particles of from between approximately 40 percent by volume and 65 percent by volume.

3. The composite of claim 2 comprising a concentration of said particles of from between approximately 50 percent by volume and 60 percent by volume.

4. The composite of claim 1 wherein said composite comprises an energy density of greater than approximately 6 joules/cc.

5. The composite of claim 4 comprising an energy density of greater than approximately 12 joules/cc.

6. The composite of claim 1 wherein said ceramic particles comprise barium titanate.

7. The material of claim 6 wherein said ceramic particles comprise barium strontium titanate.

8. The composite of claim 1 wherein said thermoset polymer system comprises a liquid epoxy polymer.

9. The composite of claim 1 wherein said ceramic particles comprise nano-size particles.

10. The composite of claim 9 wherein said ceramic particles comprise a size of between approximately 10 nm and 1 μm.

11. The composite of claim 10 wherein said ceramic particles comprise a size of between approximately 50 nm and 500 nm.

12. The composite of claim 11 wherein said ceramic particles comprise a size of between approximately 100 nm and 300 nm.

13. The composite of claim 1 being solvent-free.

14. A molded structure comprising a high dielectric constant composite, said composite comprising at least one thermoset polymer system and at least one particle filler comprising ceramic particles, said composite comprising a concentration of said particles of from between approximately 35 percent by volume and 70 percent by volume.

15. The structure of claim 14 wherein said composite comprises a concentration of said particles of from between approximately 35 percent by volume and 70 percent by volume.

16. The structure of claim 15 wherein said composite comprises a concentration of said particles of from between approximately 40 percent by volume and 65 percent by volume.

17. The structure of claim 14 wherein said composite comprises an energy density of greater than approximately 6 joules/cc.

18. The structure of claim 17 wherein said composite comprises an energy density of greater than approximately 12 joules/cc.

19. The structure of claim 14 wherein said ceramic particles comprise barium titanate.

20. The structure of claim 19 wherein said ceramic particles comprise barium strontium titanate.

21. The structure of claim 14 wherein said thermoset polymer system comprises a liquid epoxy polymer.

22. The structure of claim 14 wherein said ceramic particles comprise nano-size particles.

23. The structure of claim 22 wherein said wherein said ceramic particles comprise a size of between approximately 10 nm and 1 μm.

24. The structure of claim 23 wherein said wherein said ceramic particles comprise a size of between approximately 50 nm and 500 nm.

25. The structure of claim 24 wherein said wherein said ceramic particles comprise a size of between approximately 100 nm and 300 nm.

26. The structure of claim 14 wherein said composite is solvent-free.

27. The structure of claim 14 wherein said ceramic particles are aligned in said composite.

28. The structure of claim 17 wherein said ceramic particles are aligned in said composite in an arrangement consistent with the application of an alternating high voltage current to said composite.

29. A method for fabricating a molded structure comprising a high dielectric constant composite, the method comprising combining at least one thermoset polymer system and at least one particle filler comprising ceramic particles, the composite comprising a concentration of said particles of from between approximately 35 percent by volume and 70 percent by volume.

30. The method of claim 29 wherein the composite comprises a concentration of said particles of from between approximately 40 percent by volume and 65 percent by volume.

31. The method of claim 30 wherein the composite comprises a concentration of said particles of from between approximately 50 percent by volume and 60 percent by volume.

32. The method of claim 29 wherein the composite comprises an energy density of greater than approximately 6 joules/cc.

33. The method of claim 32 wherein the composite comprises an energy density of greater than approximately 12 joules/cc.

34. The method of claim 29 wherein the ceramic particles comprise barium titanate.

35. The method of claim 34 wherein the ceramic particles comprise barium strontium titanate.

36. The method of claim 29 wherein the thermoset polymer system comprises a liquid epoxy polymer.

37. The method of claim 29 wherein the ceramic particles comprise nano-size particles.

38. The method of claim 29 further comprising the step of applying an alternating high voltage current to the composite to align the ceramic particles in the composite.

39. The method of claim 29 further comprising the step of ball milling the ceramic particles prior to mixing.

40. The method of claim 29 further comprising the steps of:
dispersing the ceramic particles in a solvent prior to mixing the ceramic particles with the thermoset polymer system; and
removing the solvent after addition of the thermoset polymer system.

41. The method of claim 29 further comprising the step of disposing the composite into a mold.

42. The method of claim 41 further comprising the steps of:
applying a heat of a moderate temperature to the composite to control the flow of the composite; and
disposing the composite into the mold.

43. The method of claim 42 wherein the temperature is below the activation temperature for curing of the composite.

44. The method of claim 43 wherein the temperature is between approximately 30° C. and 80° C.

45. The method of claim 41 wherein the mold comprises a thin cross-section and is oriented so that the axis of the thin cross-section is vertical.

46. The method of claim 41 wherein the step of disposing the composite into the mold comprises pumping the composite into the mold.

47. The method of claim 41 further comprising the step of placing the composite and the mold under a vacuum of less than atmospheric pressure.

48. The method of claim 47 further comprising the step of placing the composite and the mold under a vacuum of from between approximately 50 mtorr and 250 mtorr.

49. The method of claim 48 further comprising the step of placing the composite and the mold under a vacuum of from between approximately 60 mtorr and 200 mtorr.

50. The method of claim 29 further comprising allowing the composite to cure and applying a pressure to the composite during curing so that bubbles can compress.

51. The method of claim 50 wherein the pressure is between approximately 50 psi and 150 psi.

52. The method of claim 51 wherein the pressure is between approximately 90 psi and 110 psi.
